(19) United States
(12) Patent Application Publication
(10) Pub. No.: US 2007/0156480 A1
(43) Pub. Date: Jul. 5, 2007

(54) Commitment-process project-management methods and systems

(75) Inventors: Rohit Jain, West Allis, WI (US); Michael Hamel, Cedarburg, WI (US); Thomas Sullivan, Hales Corners, WI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Metavante Corporation, Milwaukee, WI (US)

(21) Appl. No.: 11/274,757

(22) Filed: Nov. 14, 2005

(51) Int. Cl. G05B 19/418; G06F 9/46

(52) U.S. Cl. 705/8

(57) ABSTRACT

Methods and systems are provided for coordinating a project-commitment process for an organization. An interface is provided to a computational system for coordinating communications among personnel of the organization. A request is received from a customer or an agent of the customer at the organization. The request includes specification of project parameters for a project. A series of communications within the organization are coordinated using the computational system to evaluate a capacity of the organization to implement the project in accordance with the project parameters. From the evaluated capacity, it is determined whether the organization may commit to performing the project on behalf of the customer.

### BACKGROUND OF THE INVENTION

This application relates generally to commitment management. More specifically, this application relates to methods and systems of managing a solution-assurance process for projects.

There are numerous systems currently available that aid businesses in the implementation of projects. These systems are often designed in a generic fashion that permits them to be applied to a wide range of project types in a diverse variety of industries. Once parameters for a particular project have been defined, such systems typically provide techniques for identifying benchmarks, measuring progress towards achieving the benchmarks according to specified timelines, and integrating such measurements into an ongoing analysis of the project for multiple individuals and subparts of the project. These systems thus provide an effective tool for businesses to monitor the status of the project during and after its implementation, and thereby to identify weaknesses with its progress, where budgets might be exceeded, where deviations might be developing from desired timelines, and the like. This information then provides the business with a management tool that permits it to identify deviations from a project plan when they are initially forming so that corrective actions may be considered.

While all of this information is undoubtedly of value to the business once it has begun implementation of a project, it does not help make the decision initially whether to take on specific projects. But such a decision, once made, may have far-reaching consequences for an organization—it may impact the time that personnel have to devote to existing projects, and it may increase competition for potentially limited resources, both internally within the business and with external suppliers. These consequences may, in turn, manifest themselves by affecting the profitability of the organization as increased strains on both personnel and other resources disturb the balance between efforts on selling products and efforts to develop new products or improve existing products.

There is accordingly a general need in the art for methods and systems that can assist businesses in determining whether to commit to projects.

### BRIEF SUMMARY OF THE INVENTION

Embodiments of the invention provide methods and systems that enable a commitment process to be implemented for controlling the identification, assessment, and estimation of proposed business opportunities and initiatives. The use of such a commitment process advantageously enables sales and service teams to make commitments to prospects and customers (referred to collectively herein as “customers”) with greater completeness and accuracy. It further permits suppliers to estimate, schedule, obtain resources, and deliver higher quality products and services at a lower cost.

In a set of embodiments, a method is provided of coordinating a project-commitment process for an organization. An interface is provided to a computational system for coordinating communications among personnel of the organization. A request is received from a customer or agent thereof at the organization. The request includes specification of project parameters for a project. A series of communications within the organization are coordinated using the computational system to evaluate a capacity of the organization to implement the project in accordance with the project parameters. From the evaluated capacity, it is determined whether the organization may commit to performing the project on behalf of the customer or prospective customer.

In some such embodiments, the computational system includes a plurality of templates defining information to be collected during the series of communications. Coordinating the series of communications then comprises providing the templates to the personnel for completion and transmitting the completed templates over the interface. In some instances, a log may be stored on the computational system of intermediate determinations made in evaluating the capacity of the organization as a result of the series of communications.

In several embodiments, a series of communications are coordinated with potential suppliers of materials and/or services to be used in performing the project to evaluate a capacity of the potential suppliers to provide the materials and/or services. The determination of whether the organization may commit to performing the project on behalf of the customer thus further accounts for the evaluated capacity of the potential suppliers. At least one of the potential suppliers might be a supplier internal to the organization.

Alternatively, at least one of the potential suppliers might be a supplier external to the organization, in which case the interface to the computational system may include an external interface to coordinate communications with the external supplier. A supplier log may sometimes be maintained with the computational system. The supplier log identifies materials and/or services provided by a plurality of potential suppliers. In one embodiment, the supplier log further includes rankings of past experiences of the organization with the plurality of potential suppliers.

A series of communications between personnel of the organization and the customer or the agent may also be coordinated with the computational system to further define aspects of the project parameters. The organization may sometimes comprise a plurality of separate departments; in such instances, coordinating the series of communications may comprise coordinating a series of communications between the separate departments.

A proposal may be generated with the computational system for transmission to the customer or the agent. In some embodiments, the proposal accepts the project, but in other embodiments, the proposal is for modification of the project parameters. Examples of project parameters include those that define a completion time for the project and those that define a cost limit for the project.

Methods of the invention may be embodied in a system for coordinating a project-commitment process for an organization. The system comprises a communications interface, a storage device, a processor, and a memory. The communications interface is configured to effect communications among personnel of the organization. The processor is in communication with the communications interface and with the storage device. The memory is coupled with the processor and comprises a computer-readable storage medium having a computer-readable program embodied therein. The computer readable program comprises instructions for coordinating the project-commitment process as described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 is a schematic illustration of a structure within which embodiments of the invention may be implemented;

FIG. 2 is a schematic drawing illustrating a structure for a proposal-commitment evaluation system on which methods of the invention may be implemented; and

FIGS. 3A-3E are flow diagrams that summarize various aspects of the invention in different embodiments.

### DETAILED DESCRIPTION OF THE INVENTION

Embodiments of the invention provide methods and systems for managing a process for committing to projects. As used herein, the term “project” is intended to be construed broadly as referring to any assignment to be performed over a period of time. It is generally anticipated that embodiments of the invention will be especially valuable to organizations, particularly business organizations, that implement projects that involve multiple components of the organization and are performed over an extended period of time. Specifically, certain embodiments of the invention apply to projects that require contributions by, and interactions among, multiple individuals employed by an organization, drawing on physical resources for a period of time that is typically at least months. The extent to which a given project impacts the time of individuals, their need to interact, and/or the use of physical resources depends on the specific details of that project.

Merely by way of example, there may be several different types of projects that may be accommodated by the methods and systems of the invention. For instance, one type of project may comprise a product-design project in which some product to be sold by the organization is designed. Such a project may involve the time and expertise of engineers, product-market experts, financial forecasters, and the like. Another type of project may comprise a software-design project in which a piece of software to be sold by the organization is designed, implicating the time of programmers, testing staff, and the like; the software could be software that is expected to be widely distributed at a relatively low individual cost, or could be specialized software written for a single client. While product-design and software—design projects are generally similar in that they involve the design of some item to be sold by the organization, they tend to affect the use of physical resources differently—product designs typically require the fabrication of models on which physical tests are performed, while software designs are generally evaluated using virtual processes. Other types of projects that may be accommodated include manufacturing projects in which a manufacturing process is developed for a previously designed product. In some instances, consulting projects may be managed in which an organization is hired on a consulting basis to evaluate and recommend modifications to procedures used by other organizations. These various examples provide only a small sample of the variety of projects that may be accommodated by embodiments of the invention; those of skill in the art will readily recognize numerous other kinds of projects that also fall within the scope of the invention.

The methods and systems of the invention may implement a standardized workflow process to determine whether to commit to execution of a project. In embodiments where the process is implemented for an organization, the methods and systems of the invention may additionally manage an interface between departments of the organization as part of implementing the standardized workflow process. In particular, the interface permits relevant information to be exchanged between departments involved with project-initiation decisions and departments involved with ultimate delivery of the results of implementing the project. For example, “project-initiation departments” may include portions of the organization involved in interacting with the customer or prospective customer to collect project-definition parameters such as budgets, time constraints, product requirements, and the like. For example, the project-initiation departments might include sales departments with staff that not only collect such information but also inform customers of the capabilities of the organization, its past performance on similar projects, and the like. The “project-delivery departments” may include portions of the organization involved in the actual implementation of the project, such as engineering departments, manufacturing departments, programming departments, packaging departments, and the like.

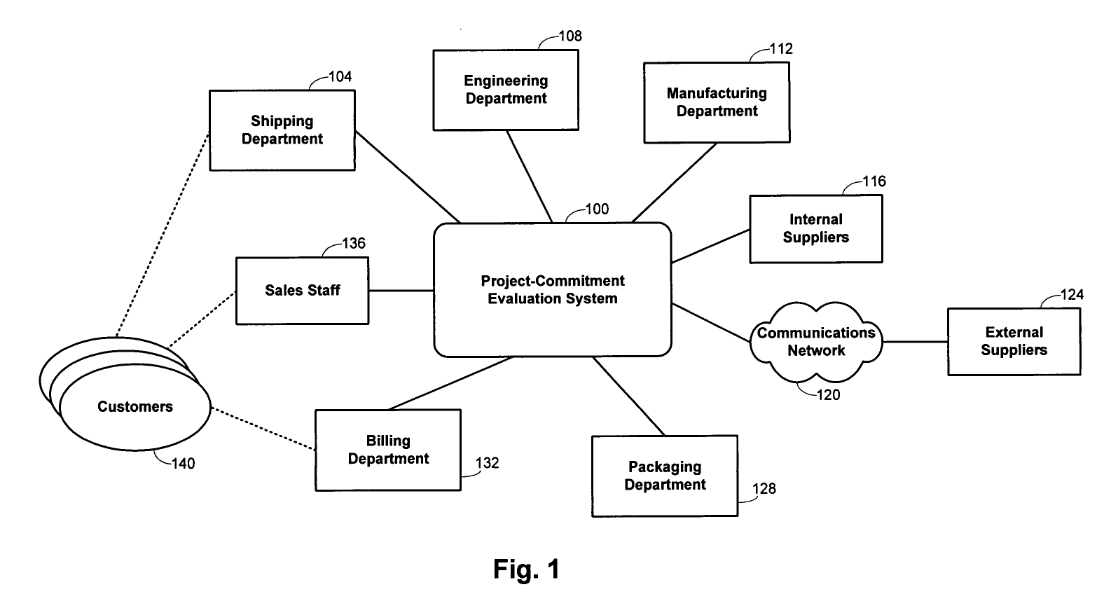

An overview of a structure for a system of the invention that may be used in implementing the commitment process is provided schematically in FIG. 1. Briefly, the system permits coordinated storage of data for use by a plurality of departments within an organization. These data may be used in combination with communications among the departments, coordinated by the system. Individuals within each of the departments may interface with the system in any of a variety of ways, although a convenient mechanism is with a browser interface with the system operating as an intranet. In such embodiments, the intranet maintains security by acting as a private network, limiting communications to be within the organization. In other embodiments, the methods and systems of the invention may be implemented across multiple organizations, in which case a convenient interface may be a browser interface using a public network such as the Internet. In such embodiments, security may be provided by using encryption and other security techniques known to those of skill in the art, thereby permitting communications among organizations in a manner similar to that described below for an embodiment having a single organization.

The data are stored by, and communications coordinated by, a project-commitment evaluation system 100. The drawing shows a number of different departments within an organization that may be interfaced with the system 100. The identification of specific departments is intended to be illustrative rather than limiting; in other embodiments, different combinations of departments may be included, some of the departments might not exist, additional departments might be connected with the system 100, the functionality of some departments might be merged or split, and the like. In the drawing, examples of project-initiation departments include the sales staff 136, which is responsible for interacting with the customers 140 to define project requirements by assessing the needs of the customers. Performance of this responsibility is aided when the sales staff 136 are knowledgeable about the general capabilities of the organization so that actual implementation of the commitment process may begin with a set of proposed requirements that are known to be roughly compatible with the abilities of the organization. Examples of the project-delivery departments shown in the drawing may include the engineering department 108, which includes engineers having technical skills for designing products; the manufacturing department 112, which includes individuals and machinery suitable for actually making the products; and the packaging department 128, which includes individuals and machinery for putting the manufactured products in a form suitable for delivery.

Operation of the organization may involve additional departments beyond those that operate as project-initiation departments and product-delivery departments. Many of these additional departments may also provide information that is valuable in determining whether to commit to projects. One example of such a department shown in FIG. 1 is the billing department 132, which may provide information during the commitment process relevant to budgetary factors, in addition to serving as a centralized division for coordinating payments for services by the customers 140. Similarly, a shipping department 104 may provide information that affects commitment to the project with information relating to the organization's capacity to deliver the products once they have been prepared for delivery by the packaging department 128. This may be in addition to other functions that it performs, such as actual arranging the delivery of the packaged products.

Determinations of whether to commit to projects may depend on other factors in addition to whether resources exist to engineer a product, to manufacture a product, to package a product, to ship a product, etc. One particular factor is whether sufficient materials are available for these functions. The project-commitment evaluation system 100 may accordingly also be provided in communication with various suppliers of materials to evaluate this aspect. Materials may be supplied internally by internal suppliers 116 or may be supplied by external suppliers 124 outside the organization. Even in embodiments where communications within the organization take place over a private network, communications with external suppliers 124 may use a separate communications network 120, such as a public network like the Internet equipped with security protocols to protect the information being exchanged.

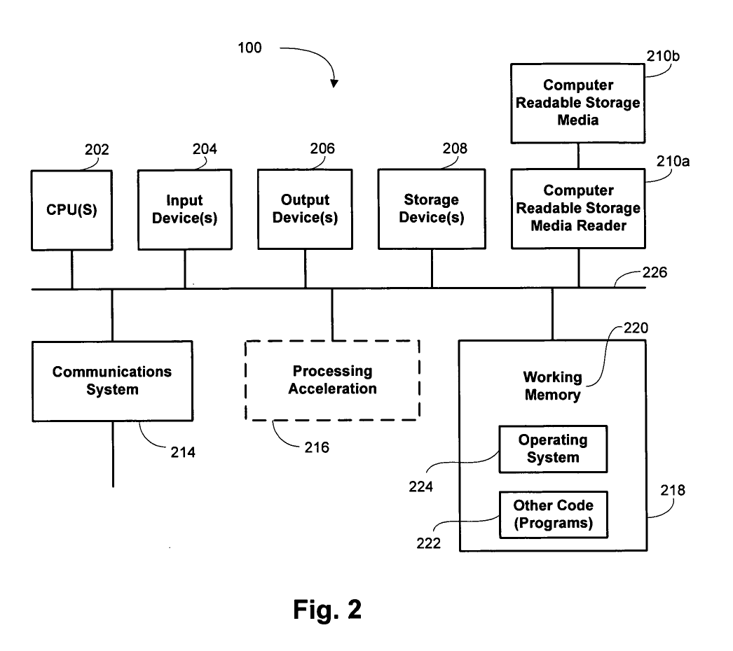

The project-commitment evaluation system 100 may advantageously be embodied on a computational device such as illustrated schematically in FIG. 2, which broadly illustrates how individual system elements may be implemented in a separated or more integrated manner. The system 100 is shown comprised of hardware elements that are electrically coupled via bus 226. The hardware elements include a processor 202, an input device 204, an output device 206, a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with the various departments and other individuals described above.

The project-commitment evaluation system 100 also comprises software elements, shown as being currently located within working memory 220, including an operating system 224 and other code 222, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

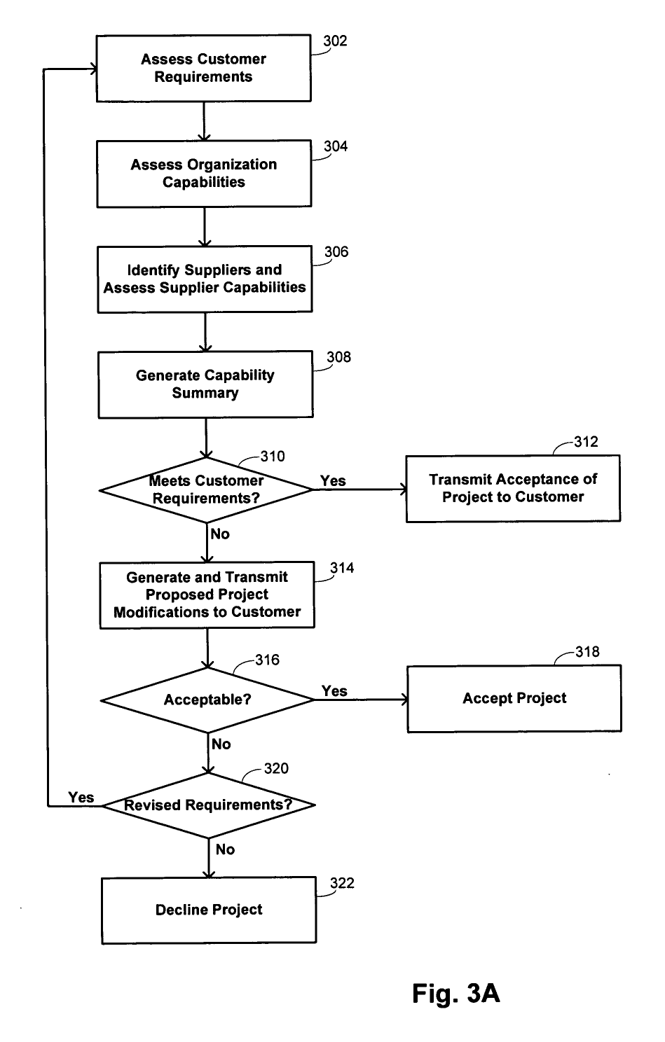

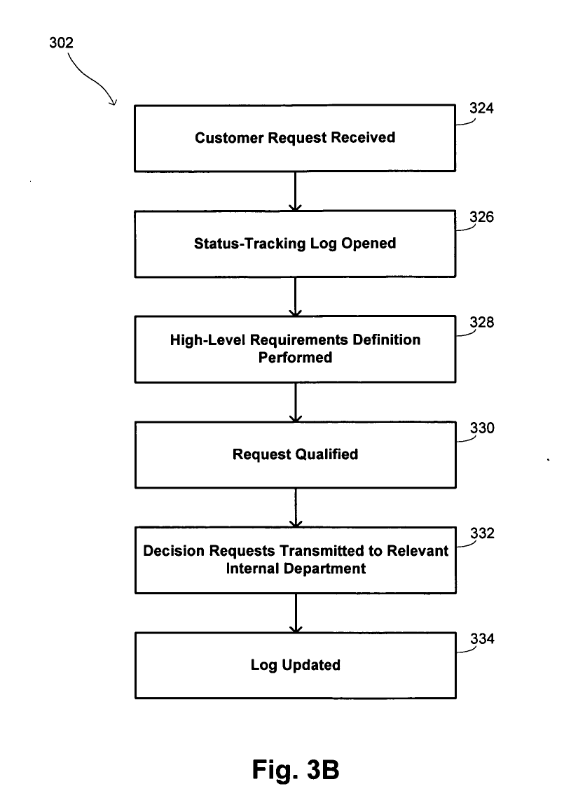

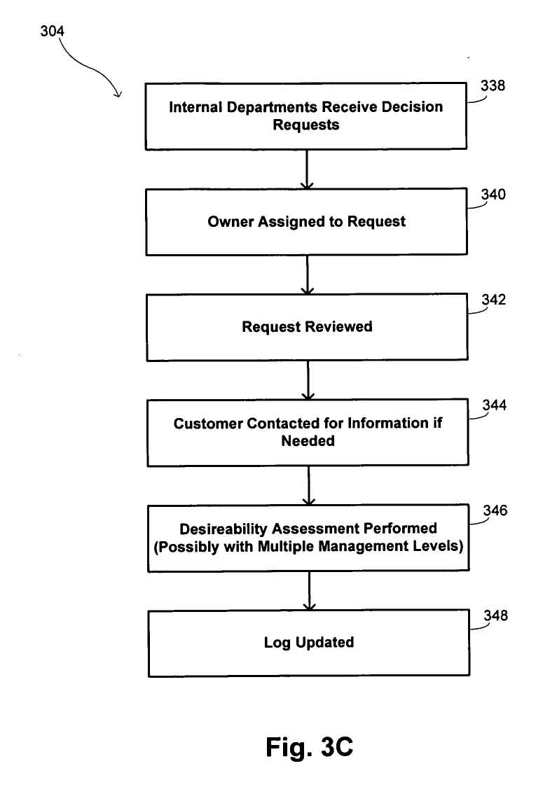

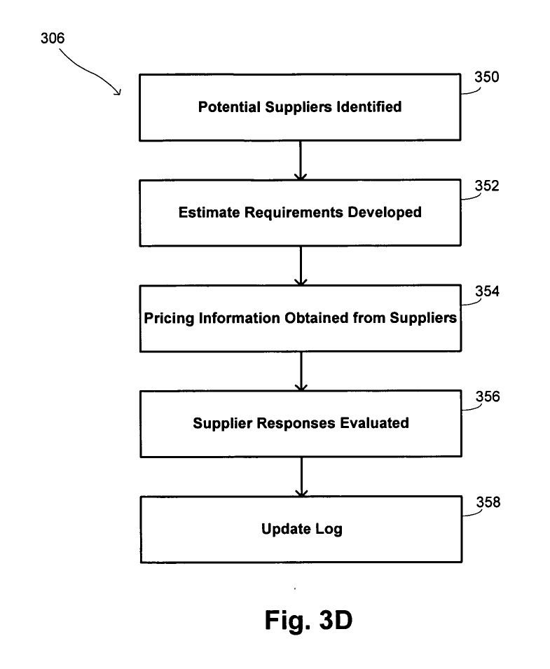

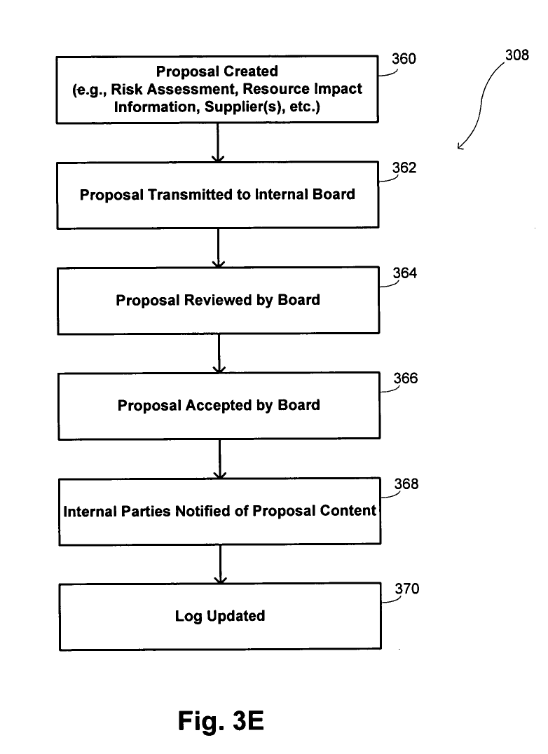

Methods of the invention that may be implemented with the system of FIG. 1 are illustrated with flow diagrams for a number of embodiments in FIGS. 3A-3E. An overview of the methods is provided with the flow diagram of FIG. 3A, with more detailed aspects of some of the blocks of FIG. 3A being provided with the flow diagrams of FIGS. 3B-3E. The functions that are executed with the methods may be performed by different parties interfaced with the project-commitment evaluation system 100 or may be performed by the project-commitment evaluation system 100 itself. In all cases, the specific inclusion and order of functions in the drawings is not intended to be limiting. In alternative embodiments, some of the functions may be omitted, additional functions may be performed, and/or the order in which the functions are executed may be changed. In some embodiments, some of the functions are performed in parallel so that they may be ongoing at the same time.

Evaluation of a project may begin at block 302 of FIG. 3A by assessing the requirements of a customer. Such requirements generally specify such information as what the terms of the project are to be, including definition of completion markers, a budget for the project, and general time constraints for completion of the project. Further details of block 302 are provided with the flow diagram of FIG. 3B, which shows that assessment of customer requirements may begin at block 324 by receiving a customer request. The customer is generally an external party and the request may be received internally in a receiving area. In some embodiments, the request is conveniently formatted according to a request template, which may have fields for entry of information to ensure that data relevant for the subsequent analysis is collected. A status-tracking log is accordingly opened at block 326 and will be updated at various stages during the process as described below.

High-level requirements are defined at block 328. Definition of such requirements at this level may result in specification of relatively broad objectives of the project rather than explicit fine details of what is to be achieved of the project. It is generally anticipated that defining the high-level requirements may require input from the customer in the form of responses to questions developed from the information in the request, and the project-commitment evaluation system 100 may be equipped to coordinate communications to receive such input. At block 330, the request is qualified. Such a process applies a qualification methodology to establish more detailed specification of project requirements. This methodology may involve additional interaction with the customer, using the project-commitment evaluation system 100 to provide an interface for receiving responses to queries. In addition, qualification of the request may involve the implementation of department policies and service-level agreements, thereby relying on input from relevant departments that is also coordinated by the project-commitment evaluation system 100. Incidental to qualifying the request is setting expectations for project results with the customer. This may involve discussions with the customer to ensure the customer has a good understanding of any limitations on what may be achieved by the organization, particularly with respect to limitations on objectives that are to form part of implementing the project and how pricing for the customer is determined. A communication establishing such expectations may accordingly be generated with the project-commitment evaluation system 100 and transmitted to the customer.

Decision requests are transmitted to relevant internal departments at block 332 by the project-commitment management system 100. Such departments may include those identified in FIG. 1 and may include an account manager assigned to the project, product management personnel, and group or senior management. The status-tracking log is updated at block 334 to record that the previous actions have been taken and perhaps including details of any decisions that were made as part of the process.

In addition to assessing the customer's requirements in this way, the organization's capabilities are assessed at block 304 of FIG. 3A. The assessment of the customer requirements and of the organization capabilities may take place concurrently or consecutively in different embodiments. In some instances, the two functions may loop, with determinations made about customer requirements being used to inform aspects of the process used to assess organization capabilities, and vice versa.

A more detailed illustration of how the organization capabilities may be assessed is provided with the flow diagram of FIG. 3C. The assessment may be prompted at block 338 by internal departments receiving decision requests. An owner is assigned to the request at block 340 as an individual (or perhaps group of individuals in some instances) to oversee the assessment. An identity of the owner may be maintained by the project-commitment evaluation system 100. The request is reviewed by the owner at block 342 to determine whether there are any issues that require clarification or otherwise need to be addressed. If so, the request may be discussed with the customer at block 344 so that the owner has sufficient information. When the owner does have sufficient information, either because there were no issues identified when the request was reviewed at block 342 or because the issues were resolved through discussion with the customer at block 344, a business-unit template may be completed as a precursor to performing a desirability assessment.

The desirability assessment seeks to obtain sufficient information internally from relevant parties to determine whether the project is one that the organization would view favorably in taking on. This assessment is performed at block 346 and may involve a number of different parties in the organization placed at different levels, such as at product-management or group or senior management levels. Individuals at these levels are identified and participate in the desirability assessment after receiving a notification generated by the product-commitment evaluation system. Information that may be used in assessing desirability of the project includes budgeting information, strategic goals of the organization or of individual departments, and the like. In some instances, similar projects that have been performed or rejected in the past may also be used in the desirability assessment. The reasons for rejection of the past project may still apply, causing the current proposed project to be deemed undesirable, or may have changed, causing the current proposed project to be viewed more favorably. In addition, projects that have actually been completed may provide a valuable source of information for determining whether an initial assessment was correct, effectively permitting repetition of a past mistake to be avoided by recognizing similar features in the current proposed project.

The results of the desirability assessment are included in the status log, which is accordingly updated at block 348.

At block 306 of FIG. 3A, suppliers and identified are their capabilities assessed. Methods by which this may be done is illustrated in further detail with the flow diagram of FIG. 3D. At block 350, a set of potential suppliers of raw materials, consulting consulting a supplier handbook that identifies what different suppliers have to offer, whether such suppliers have been approached by the organization for past projects, what their fees are, and the like. Conveniently, the supplier handbook may be provided in electronic form accessible by the owner through the project-commitment evaluation system 100. Maintaining it in such a form permits the system 100 to maintain supplementary records associated with each supplier. For instance, merely by way of example, every time the supplier is used by the organization for a project, the project owner might be asked to rate the supplier on such factors as reliability, timeliness, accuracy, etc. so that the supplier handbook includes average and historical information that may be consulted for later projects.

At block 352, estimate requirements may be developed. Such development may sometimes make use of additional information solicited from the customer, such as in cases where the customer expresses a specific interest in having a portion of the project supplied by a particular supplier. The developed requirements may be provided to the potential suppliers so that pricing, capacity, and other information may be collected from the potential suppliers at block 354. A determination of which suppliers to use if the project is accepted is based on evaluation of the supplier responses at block 356. In some cases, this determination may result from an iterative process in which the estimate requirements are modified in response to some of the supplier responses, with all or a subset of the potential suppliers then being asked to provide revised responses in accordance with the modifications. This process may generally include telephone, email, fax, and in-person communications between the project owner and the supplier. Once the suppliers for the project have been identified in this way, the status log may be updated with the collected information and/or the decision to identify particular suppliers at block 358.

Having assessed the customer requirements, the organization capabilities, and the supplier capabilities, a capability summary may be generated a block 308, perhaps including a specific proposal for transmission to the customer. This proposal may be subject to a number of internal review processes that are coordinated by the project-commitment evaluation system 100, as illustrated by the more detailed flow diagram of FIG. 3E. Initial generation of the proposal at block 360 may account for such factors as a risk assessment of the ability for the organization to complete the project, information on the impact that acceptance of the project will have on the organization, which suppliers are to be used, and the like. The project owner may be assisted by the system 100 in generating the proposal by tools supplied with an interface to the system 100. For example, a template may be provided that the project owner uses, thereby ensuring that the proposal includes information that will be needed for the internal review processes.

At block 362, the proposal is transmitted by the project-commitment evaluation system 100 to an internal board assigned to review proposals. Such a board may comprise senior or group-level management personnel who review the proposal with the assistance of the system 100. The system acts as a resource that maintains documents and other information collected during the various assessment stages that members of the board may wish to review. It may also act to coordinate the scheduling of meetings among the board members, provide reminders of evaluation criteria to be applied in reviewing the proposal, provide templates for collecting evaluations from different board members, and the like.

Once the proposal is accepted by the board at block 366, internal parties may be notified of the content of the proposal at block 368. These may be parties at various levels, including product management, suppliers, and senior management, who may be involved with actual implementation of the project. The status log is updated at block 370 to reflect that the proposal been accepted and communicated within the organization.

Returning to FIG. 3A, one of the intents of the various assessment processes and generation of the capability summary is to permit a determination to be made whether the initial customer requirements may be met by the organization, as checked at block 310. If so, the project may be accepted immediately and an acceptance of the project transmitted to the customer at block 312. If the initial requirements cannot be met, a proposal of modifications to the customer requirements that are within the capabilities of the organization may be generated at block 314 for transmission to the customer. The customer is then afforded an opportunity to consider whether a project having a modified scope is acceptable. In many instances, the customer may have a long-term relationship with the organization, preferring to pursue a modified project with an organization having known reliability than having to find a different organization with unknown reliability. In many instances, the proposed modification might well be acceptable to the customer, reflecting a need for the organization to take somewhat more time than the customer might initially have preferred or having to charge a somewhat higher price, but not inconsistent with what the customer is willing to accept.

If the modifications are acceptable to the customer, the project may be accepted at block 318. If the modifications are not acceptable, the customer may still have the opportunity to propose its own revisions to its initial requirements, attempting to find a compromise that may still permit the project to be undertaken by the organization. If it is willing to do so, as checked at block 320 the revised requirements are supplied by the customer and the commitment process repeated to evaluate them. If the customer is unwilling to revise its requirements and the modifications proposed by the organization are also unacceptable to it, the project may be declined at block 322.

The methods and systems of the invention thus facilitate the management of resources between various departments to enable the commitment of resources prior to execution of a contract with a customer for performing a project. While the foregoing description has focused on a single project, it should be appreciated that multiple projects may be considered and evaluated by the system simultaneously. In many instances, these multiple projects might ultimately compete for the some resources. By permitting real-time monitoring and management of various proposals throughout the organization, resources may be committed without conflict prior to and as a basis for a contractual arrangement. The thorough evaluation process that is completed prior to acceptance of a project is also expected to improve the accuracy in estimating costs for undertaking a project and evaluating its benefit, including specifications for quality, operability, and maintainability.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of coordinating a project-commitment process for an organization, the method comprising:
providing an interface to a computational system for coordinating communications among personnel of the organization;
receiving a request from a customer or an agent of the customer at the organization, the request including specification of project parameters for a project;
coordinating a series of communications within the organization using the computational system to evaluate a capacity of the organization to implement the project in accordance with the project parameters; and
determining from the evaluated capacity whether the organization may commit to performing the project on behalf of the customer.

2. The method recited in claim 1 wherein:
the computational system includes a plurality of templates defining information to be collected during the series of communications; and
coordinating the series of communications comprises providing the templates to the personnel for completion and transmitting the completed templates over the interface.

3. The method recited in claim 1 further comprising storing a log of intermediate determinations made in evaluating the capacity of the organization as a result of the series of communications on the computational system.

4. The method recited in claim 1 further comprising coordinating a series of communications with potential suppliers of materials and/or services to be used in performing the project to evaluate a capacity of the potential suppliers to provide the materials and/or services, wherein determining whether the organization may commit to performing the project on behalf of the customer further accounts for the evaluated capacity of the potential suppliers.

5. The method recited in claim 4 wherein at least one of the potential suppliers is a supplier internal to the organization.

6. The method recited in claim 4 wherein:
at least one of the potential suppliers is a supplier external to the organization; and
the interface to the computational system includes an external interface to coordinate communications with the external supplier.

7. The method recited in claim 4 further comprising maintaining a supplier log with the computational system, the supplier log identifying materials and/or services provided by a plurality of potential suppliers.

8. The method recited in claim 7 wherein the supplier log further includes rankings of past experiences of the organization with the plurality of potential suppliers.

9. The method recited in claim 1 further comprising coordinating a series of communications between personnel of the organization and the customer or the agent with the computational system to further define aspects of the project parameters.

10. The method recited in claim 1 wherein:
the organization comprises a plurality of separate departments; and
coordinating the series of communications comprises coordinating a series of communications between the separate departments.

11. The method recited in claim 1 further comprising generating, with the computational system, a proposal accepting the project for transmission to the customer or the agent.

12. The method recited in claim 1 further comprising generating, with the computational system, a proposal for modification of the project parameters for transmission to the customer or the agent.

13. The method recited in claim 1 wherein the project parameters define a completion time for the project.

14. The method recited in claim 1 wherein the project parameters define a cost limit for the project.

15. A system for coordinating a project-commitment process for an organization, the system comprising:
a communications interface configured to effect communications among personnel of the organization;
a storage device;
a processor in communication with the communications interface and with the storage device; and
a memory coupled with the processor, the memory comprising a computer-readable storage medium having a computer-readable program embodied therein for operating the system, the computer-readable program comprising:
instructions for receiving a request from a customer or an agent of the customer at the organization, the request including specification of project parameters for a project;
instructions for coordinating a series of communications within the organization using the communications interface to evaluate a capacity of the organization to implement the project in accordance with the project parameters; and
instructions for determining from the evaluated capacity whether the organization may commit to performing the project on behalf of the customer.

16. The system recited in claim 15 wherein:
the storage device includes a plurality of templates defining information to be collected during the series of communications; and
the instructions for coordinating the series of communications comprise instructions for providing the templates over the communications interface to the personnel for completion and instructions for transmitting the completed interfaces over the communications interface.

17. The system recited in claim 15 wherein the computer-readable program further comprises instructions for storing a log of intermediate determinations made in evaluating the capacity of the organization as a result of the series of communications on the storage device.

18. The system recited in claim 15 wherein:
the computer-readable program further comprises instructions for coordinating, using the communications interface, a series of communications with potential suppliers of materials and/or services to be used in performing the project to evaluate a capacity of the potential suppliers to provide the materials and/or services; and
the instructions for determining whether the organization may commit to performing the project on behalf of the customer further account for the evaluated capacity of the potential suppliers.

19. The system recited in claim 18 wherein:
at least one of the potential suppliers is a supplier external to the organization; and
the communications interface includes an external interface to effect communications with the external supplier.

20. The system recited in claim 18 wherein the computer-readable program further comprises instructions for maintaining a supplier log on the storage device, the supplier log identifying materials and/or services provided by a plurality of potential suppliers.

21. The system recited in claim 15 wherein the computer-readable program further comprises instructions for coordinating a series of communications between personnel of the organization and the customer or the agent using the communications interface to define aspects of the project parameters.

22. The system recited in claim 15 wherein the computer-readable program further comprises instructions for generating a proposal accepting the project for transmission to the customer or the agent.

23. The system recited in claim 15 wherein the computer-readable program further comprises instructions for generating a proposal for modification of the project parameters for transmission to the customer agent.
